(19) United States
(12) Patent Application Publication
(10) Pub. No.: US 2008/0257986 A1
(43) Pub. Date: Oct. 23, 2008

(54) Water spray gun

(75) Inventors: Tsuo Fei Mau, Yuanlin Chen (TW); Tung Yang Yu, Peitou Chen (TW)

Correspondence Address: TROXELL LAW OFFICE PLLC, SUITE 1404, 5205 LEESBURG PIKE, FALLS CHURCH, VA, 22041, US

(73) Assignee: RUEY RYH ENTERPRISE CO., LTD.

(21) Appl. No.: 11/790,093

(22) Filed: Apr. 23, 2007

(51) Int. Cl. B05B 9/01

(52) U.S. Cl. 239/394

(57) ABSTRACT

A water spray gun includes a body mounted with a socket and a stopper cap and a water outlet fitting to support a water control valve, a nozzle head affixed to the water outlet passage of the body, a lever for operation by the user to rotate the water control valve and to further control the flowrate of water entering the nozzle head, a buffer member mounted in the nozzle head to buffer water pressure, a spray cap capped on the nozzle head, and a spray pattern dial mounted in the nozzle head behind the spray cap and having an adjustment plate pivotally supported between a first spray pattern plate and a second spray pattern plate with a finger rod extending out of a sliding groove of the buffer member and a sliding slot of the nozzle head for operation by the user to change the spray pattern.

### BACKGROUND OF THE INVENTION

The present invention relates to water spray guns and more particularly, to a cost-effective simple structure of water spray gun, which comprises a body mounted with a socket and a stopper cap and a water outlet fitting to support a water control valve, a nozzle head affixed to the water outlet passage of the body, a lever pivoted to the body for operation by the user to rotate the water control valve and to further control the flowing of water, a nozzle head with a buffer member connected to the water outlet passage of the body and capped with a spray cap, and a spray pattern dial mounted in the nozzle head with a finger rod extending out of a sliding slot of the nozzle head for operation by the user to control the spray pattern.

A conventional water spray gun 10 ((see FIG. 1) has a screw rod 13 extending backwards from a control valve set inside the barrel 11 and mounted with a nut 12, and a control lever 15 pivoted to the body 14 and having a top retaining member 151 fastened to the screw rod 13. When in use, the user can hold the body 14 and the control lever 15 with the hand and then pull the control lever 15 to move the screw rod 13, thereby controlling the internal control valve set.

The aforesaid conventional water spray gun has numerous drawbacks as follows: (1) During operation, the user must hold the front side of the body 14 with the hand and then press the control lever 15 and keep the control lever 15 in the pressed position to let the water spray gun eject water spray. Frequently operating the control lever 15 with the hand causes the hand to ache or to feel uncomfortable. Therefore, this design of water spray gun is not suitable for wide area application. (2) The structure and installation of the control valve set in the body 14 are complicated, resulting in high material and labor costs, not cost effective.

It is therefore desirable to provide a water spray gun that eliminates the aforesaid drawbacks.

### SUMMARY OF THE PRESENT INVENTION

The present invention has been accomplished to provide a water spray gun, which eliminates the aforesaid drawbacks. According to one aspect of the present invention, the water spray gun comprises a body mounted with a socket having an arched guide face and a water outlet opening to match with a water control valve, a nozzle head connected to the body, a lever pivoted to the body for rotating the water control valve to move a notch of a spherical valve block of the water control valve into water communication with the water outlet opening of the socket or out off the water outlet opening of the socket so as to further control the flowing of water to the nozzle head, and a buffer member mounted in the nozzle head to buffer water impact. When the water control valve is opened to let water pass, the user needs not to keep pressing the lever.

According to another aspect of the present invention, a spray pattern dial is mounted in the nozzle head for controlling water spray pattern. The spray pattern dial comprises a first spray pattern plate, which has an upper water jet hole and a lower water jet hole, a second spray pattern plate, which has an upper water jet hole and a lower water jet hole, and an adjustment plate pivotally set in between the first spray pattern plate and the second spray pattern plate and having a finger rod extending out of a sliding slot of the nozzle head for biasing by the user to control the flowing direction of water through the upper water jet holes or the lower water jet holes and to further change the spray pattern of water passing out of the spray cap at the front side of the nozzle head.

According to still another aspect of the present invention, the water spray gun is comprised of a body having mounted therein a socket, a stopper cap and a water outlet fitting to support a water control water between a water inlet passage and a water outlet passage, a lever pivoted to the body for moving the water control valve to close or open the water passage, a nozzle head connected to the water outlet passage of the body, a buffer member mounted in the nozzle head to buffer water impact, a spray cap capped on the nozzle head, and a spray pattern dial mounted in the nozzle head behind the spray cap with a finger rod of the adjustment plate thereof extending out of a sliding slot of the nozzle head for operation by the user to adjust the spray pattern. The whole structure of the water spray gun is simple, saving much material and labor costs. Therefore, the water spray gun is cost effective.

### BRIEF DESCRIPTION OF THE DRAWINGS

FIG. 1 is a perspective view of a water spray gun according to the prior art.

FIG. 2 is an exploded view of a water spray gun according to the present invention.

FIG. 3 is an elevational assembly view of the water spray gun according to the present invention.

FIG. 4 is a sectional view of the water spray gun according to the present invention.

FIG. 5 is a perspective view of the socket for the water spray gun according to the present invention.

FIG. 6 is a sectional view of the water outlet fitting for the water spray gun according to the present invention.

FIG. 7 is a sectional elevation of the body for the water spray gun according to the present invention.

FIG. 8 is a sectional view of a part of the present invention, showing the positioning of the water control valve in the body.

FIG. 9 is an elevational assembly view of the spray pattern dial for the water spray gun according to the present invention.

FIG. 10 is similar to FIG. 9 but showing the adjustment plate adjusted.

FIG. 11 is a schematic drawing showing one spray pattern of the water spray gun according to the present invention.

FIG. 12 is a schematic drawing showing another spray pattern of the water spray gun according to the present invention.

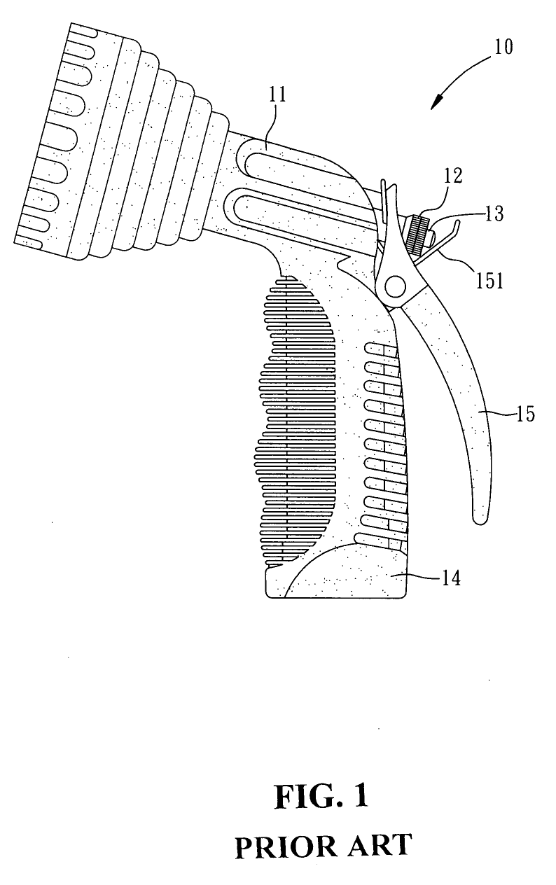

### DETAILED DESCRIPTION OF THE PREFERRED EMBODIMENTS

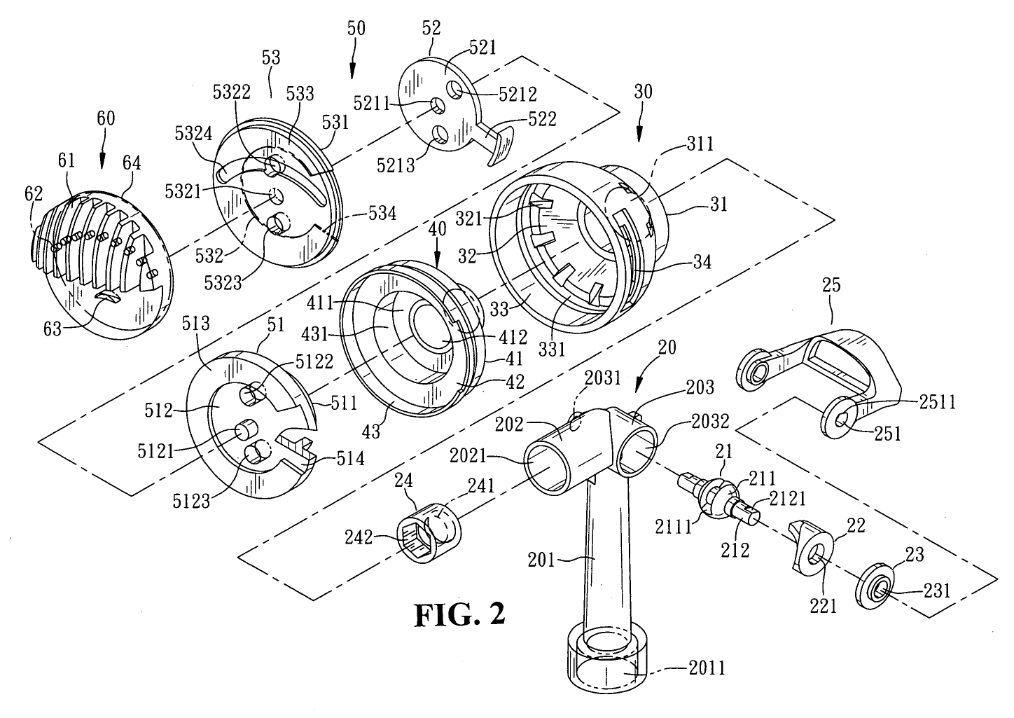

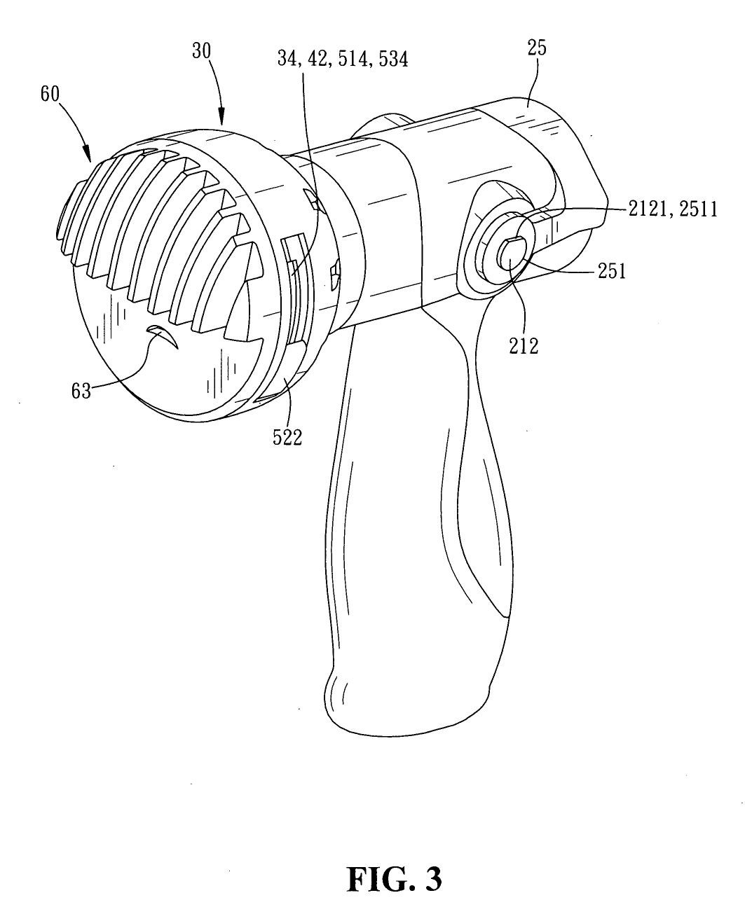

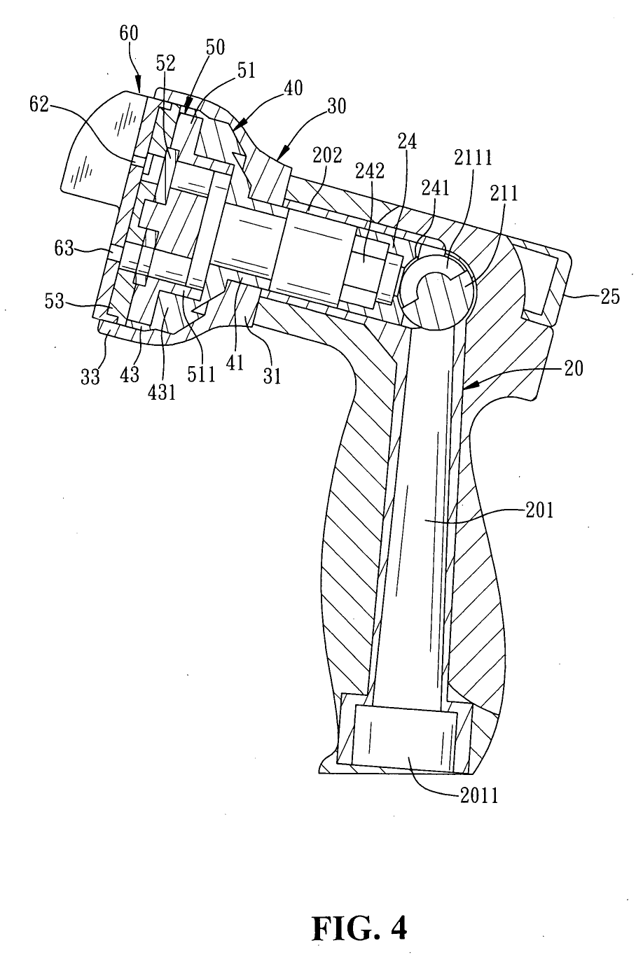

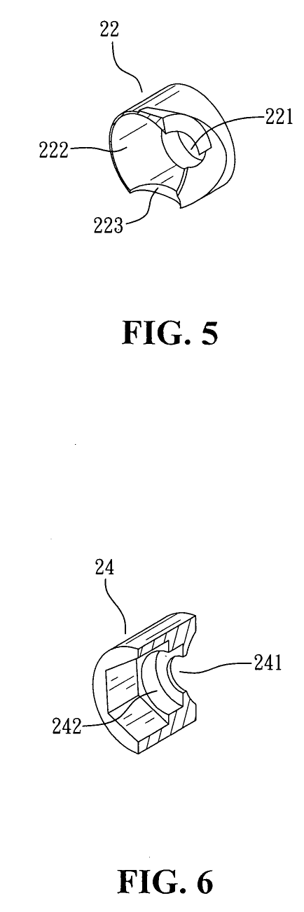

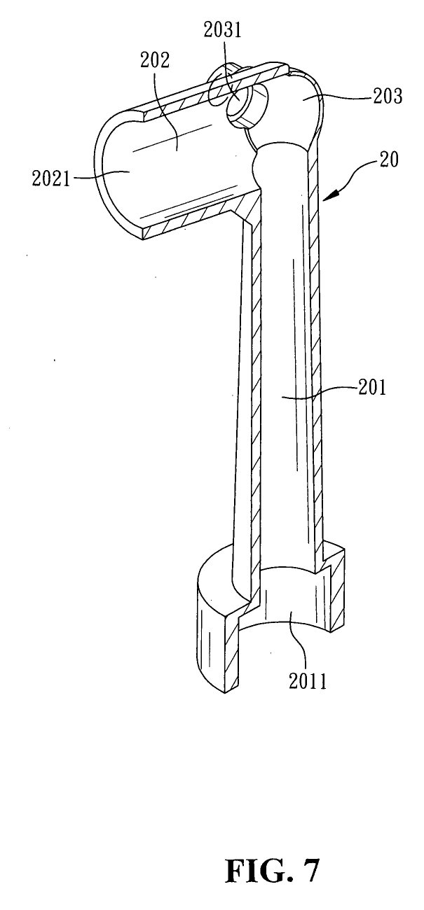

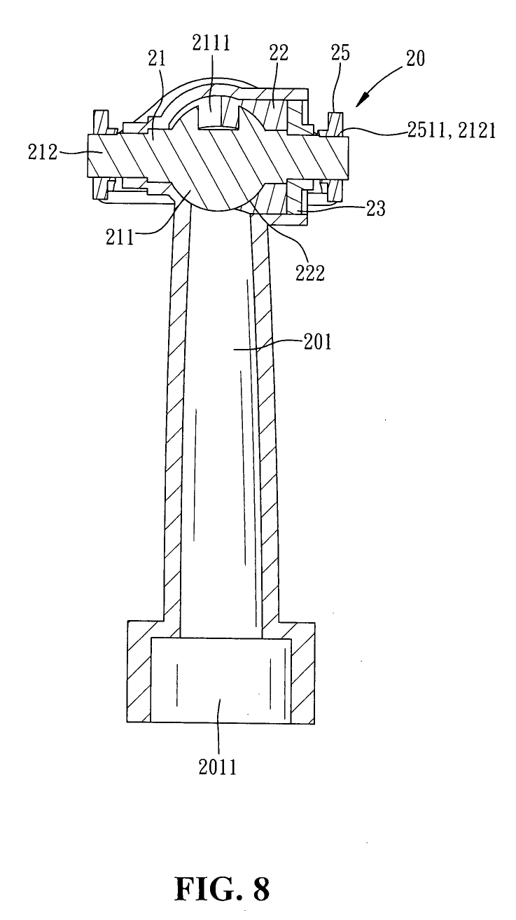

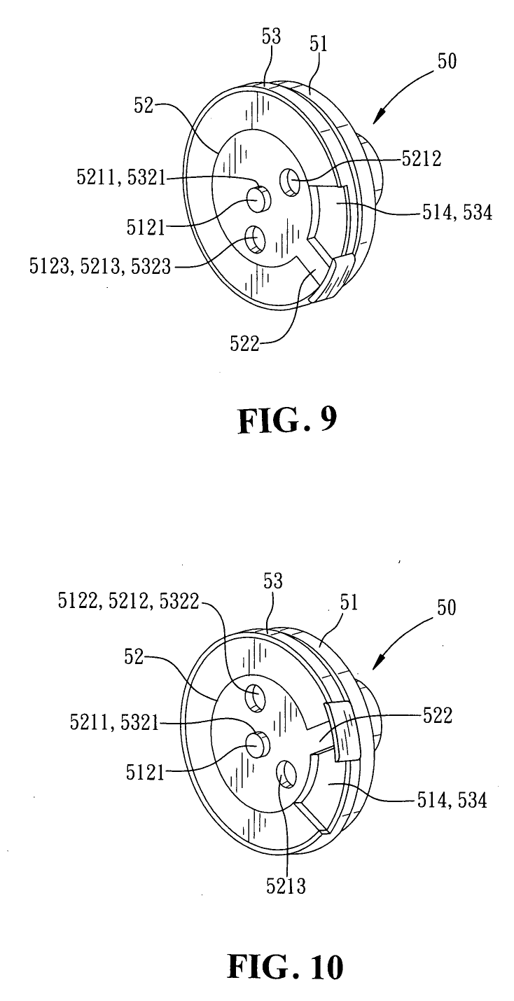

FIG. 2 is a perspective view of a water spray gun in accordance with the present invention (referring also to 3 and 4). The water spray gun comprises a body 20 (see FIGS. 7 and 8), which has mounted therein a water control valve 21, a socket 22 (see FIG. 5), a stopper cap 23 and a water outlet fitting 24 (see FIG. 6), a control lever 25, a nozzle head 30, a buffer member 40, a spray pattern dial 50 (see FIGS. 9 and 10), and a spray cap 60.

The body 20 has a water inlet passage 201, a connection hole 2011 at one end of the water inlet passage 201, a water outlet passage 202, a valve chamber 203 in communication between the water inlet passage 201 and the water outlet passage 202, and an access hole 2021 in communication with one end of the water outlet passage 202 remote from the valve chamber 203. The water inlet passage 201, the water outlet passage 202 and the valve chamber 203 are in communication with one another, showing a T-shaped profile. The valve chamber 203 has a pivot hole 2031 and a bearing hole 2032.

The water control valve 21 is mounted in the valve chamber 203, having a spherical valve block 211 and a stem 212. The spherical valve block 211 is formed integral with a middle part of the stem 212, having a crescent shaped notch 2111. The stem 212 has a cut plane 2121 on each of the two distal ends thereof. The stem 212 has its one end pivotally mounted in the pivot hole 2031 of the valve chamber 2031, and its other end inserted through a center axial hole 221 of the socket 22 and a through hole 231 of the stopper cap 23. Thereafter, the socket 22 and the stopper cap 23 are bonded to the inside wall of the valve chamber 203 and the periphery of the bearing hole 2032 by high frequency welding.

The socket 22 has an arched guide face 222 fitting over the periphery of the spherical valve block 211, a water outlet opening 223 cut from a part of the arched guide face 222 for communication with the crescent shaped notch 2111 of the spherical valve block 211 to form a water inlet passage.

The water outlet fitting 24 is bonded to the inside of the water outlet passage 202 by high frequency welding, having a water guide hole 241 curved inwards at one end and closely attached to the spherical valve block 211 of the water control valve 21 for communication with the crescent shaped notch 2111 to guide in water and a stepped water hole 242 at the other end.

The control lever 25 has two coupling holes 251 respectively disposed at two distal ends thereof and respectively coupled to the two ends of the step 212, and two cut planes 2511 respectively formed in the coupling holes 251 and fitting the cut planes 2121 of the stem 212. Therefore, the control lever 25 can be turned upwards or downwards to rotate the water control member 21.

The nozzle head 30 has a rear mounting portion 31 bonded to the periphery of the access hole 2021 of the water outlet passage 202 by high frequency welding, a water hole 311 in the rear mounting portion 21, a front coupling portion 33, a step 331 in the front coupling portion 33, a sliding slot 34 cut through the coupling portion 33, a tapered guide portion 32 connected between the rear mounting portion 21 and the front coupling portion 33, and a plurality of teeth 321 spaced around the inside wall of the tapered guide portion 32.

The buffer member 40 has a rear mounting portion 41 bonded to the inside wall of the rear mounting portion 31 of the nozzle head 30 around the water hole 311, a stop wall 411 formed in the rear mounting portion 41 and supported on the step 331 of the front coupling portion 33 and the teeth 321 of the tapered guide portion 32, a water hole 412 cut through the stop wall 411, a sliding groove 42 coupled to the sliding slot 34 of the nozzle head 30, a front accommodation portion 43, which accommodates the spray pattern dial 50, and a step 431 disposed in the accommodation portion 43.

The spray pattern dial 50 is comprised of a first spray pattern plate 51, an adjustment plate 52, and a second spray pattern plate 53. The first spray pattern plate 51 has a rear mounting portion 511 protruded from the front side and bonded to the step 431 inside the front accommodation portion 43 of the buffer member 40 by high frequency welding, a front face 512, a flange 513 extending around the front face 512, a sliding way 514 formed on the flange 513 corresponding to the sliding groove 42 of the buffer member 40, a pivot rod 5121 protruded from the center of the front face 512, and an upper water jet hole 5122 and a lower water jet hole 5123 cut through the front face 512 at two sides relative to the pivot rod 5121. The upper water jet hole 5122, lower water jet hole 5123 and the pivot rod 5121 of the first spray pattern plate 51 are arranged in a line. The second spray pattern plate 53 has a rear mounting portion 531 bonded to the flange 513 of the first spray pattern plate 51, a front face 532, a flange 533 extending around the front face 532, a sliding way 534 formed in the flange 533 corresponding to the sliding way 514 of the first spray pattern plate 51, a center pivot hole 5321 cut through the center of the front face 532 and coupled to the pivot rod 5121 of the first spray pattern plate 51, an upper water jet hole 5322 and a lower water jet hole 5323 cut through the front face 532 corresponding to the upper water jet hole 5122 and lower water jet hole 5123 of the first spray pattern plate 51, and a smoothly arched water accumulation groove 5324 disposed in communication with the upper water jet hole 5322. The adjustment plate 52 is set in between the first spray pattern plate 51 and the second spray pattern plate 53, having a flat circular base 521, a finger rod 522 radially extending from the periphery of the flat circular base 521 out of the sliding ways 514 of the first spray pattern plate and the sliding way 534 of the second spray pattern plate 53 and the sliding groove 42 of the buffer member 40 and the sliding slot 34 of the nozzle head 30, a pivot hole 5211 cut through the center of the flat circular base 521 and pivotally coupled to the pivot rod 5121 of the first spray pattern plate 51, and an upper water jet hole 5222 and a lower water jet hole 5223 cut through the flat circular base 521. However, the upper water jet hole 5222, lower water jet hole 5223 and center pivot hole 5211 of the adjustment plate 52 are not arranged in a line.

The spray cap 60 has a rear mounting portion 64 stopped against the flange 533 of the second spray pattern plate 53 and bonded to the periphery of the nozzle head 30 and by high frequency welding, a plurality of upper water jet holes 62 cut through the front and back walls and arranged in communication with the smoothly arched water accumulation groove 5324, a plurality of vertical ribs 61 protruded from the front side and respectively disposed at two sides of each of the upper water jet holes 62, and a lower water jet hole 63 in communication with the lower water jet hole 5323 of the second spray pattern plate 53 and the lower water jet hole 5123 of the first spray pattern plate 51.

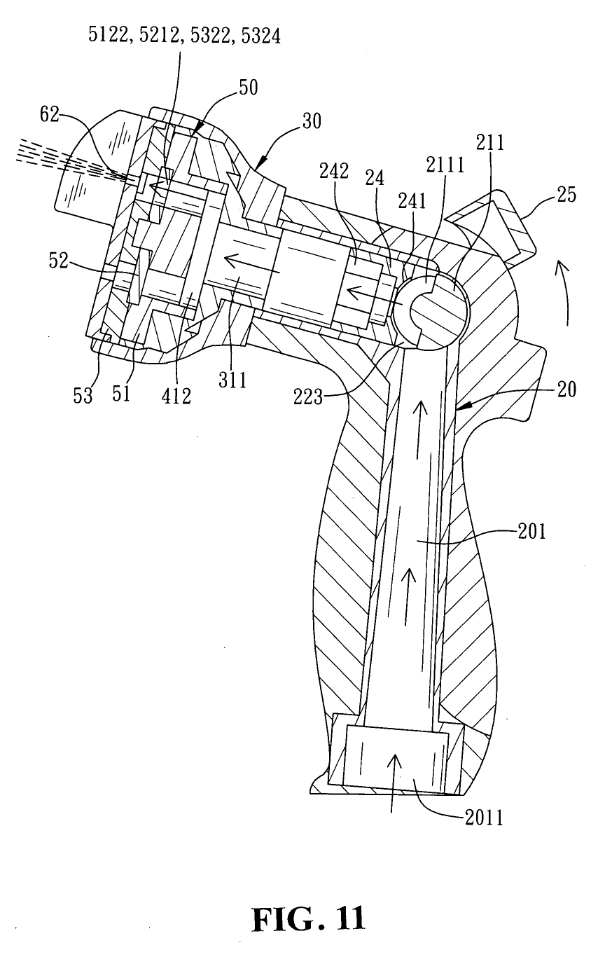

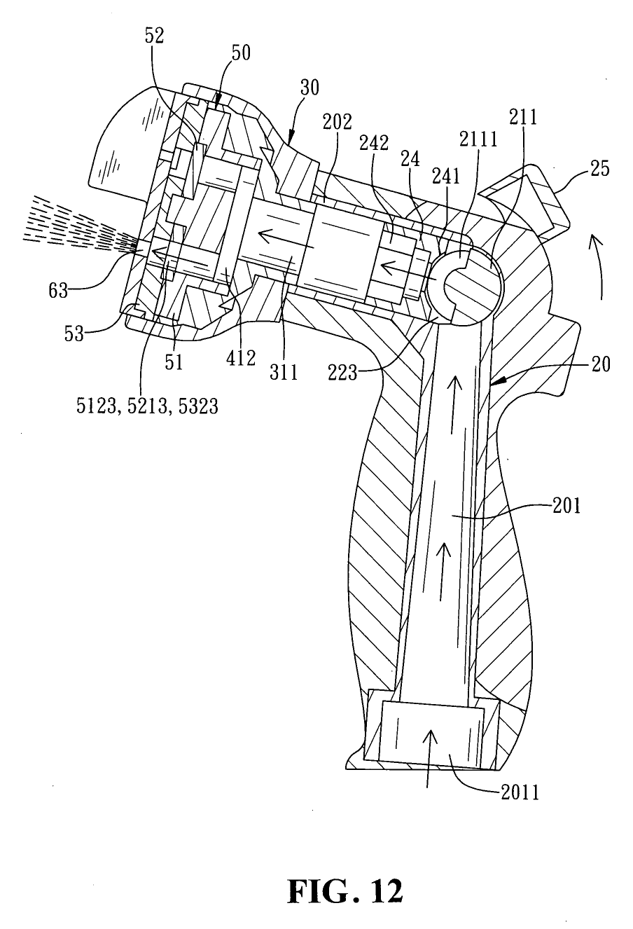

Referring to FIGS. 11 and 12, when biasing the control lever 25 upwards, the spherical valve block 211 of the water control valve 21 is rotated with the stem 212 through an angle to have the crescent shaped notch 2111 be aimed at the water outlet opening 223 of the socket 22, water is allowed to flow through the connection hole 2011 of the water inlet passage 201 into the stepped water hole 242 of the water outlet fitting 24 via the water passage defined by the crescent shaped notch 2111 of the spherical valve block 211 of the water control valve 21 and the water outlet opening 223 of the socket 22. When water entered the stepped water hole 242 of the water outlet fitting 24, the step 431 of the buffer member 40 buffers the pressure of the flowing water, lowering the impact of water on the nozzle head 30. When moving the finger rod 522 to turn the adjustment plate 52 about the pivot rod 5121 to the position where the upper water jet hole 5212 of the adjustment plate 52 in line with the upper water jet hole 5122 of the first spray pattern plate 51 and the upper water jet hole 5322 of the second spray pattern plate 53, water will be accumulated in the water accumulation groove 5324 and then forced by water pressure to spray out of the upper water jet holes 62 of the spray cap 60 over a wide area. When moving the finger rod 522 to turn the adjustment plate 52 about the pivot rod 5121 to the position where the lower water jet hole 5213 of the adjustment plate 52 in line with the upper water jet hole 5122 of the first spray pattern plate 51 and the upper water jet hole 5322 of the second spray pattern plate 53, water will be accumulated in the water accumulation groove 5324 and then forced by water pressure out of the lower water jet holes 63 of the spray cap 60.

A prototype of water spray gun has been constructed with the features of FIGS. 2˜12. The water spray gun functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A water spray gun comprising,
a body, said body having a water inlet passage, a water outlet passage, a water chamber in communication between said water inlet passage and said water outlet passage;
a water control valve mounted in said water chamber, said water control valve comprising a spherical valve block, said spherical valve block having a peripheral notch;
a control lever pivoted to said body and biasable to rotate said water control valve between an open position where said peripheral notch of said spherical valve block is in water communication between said water inlet passage and said water outlet passage and a close position where said spherical valve block blocks said water outlet passage from said water inlet passage;
a nozzle head connected to said water outlet passage, said nozzle head having a sliding slot cut through the periphery thereof;
a spray pattern dial mounted in said nozzle head, said spray pattern dial comprising a first spray pattern plate fixedly mounted inside said nozzle head, said first spray pattern plate having a plurality of water jet nozzles disposed in water communication with said water outlet passage and a pivot rod perpendicularly extending from a front side thereof, a second spray pattern plate fixedly fastened to said nozzle head in front of said first spray pattern plate, said second spray pattern plate having a plurality of water jet holes and a center mounting hole coupled to said pivot rod of said first spray pattern plate, and an adjustment plate set in between said first spray pattern plate and said second spray pattern plate and rotatable relative to said first spray pattern plate and said second spray pattern plate to selectively control communication between the water jet holes of said first spray pattern plate and the water jet holes of said second spray pattern plate and to further control the spray pattern of water, said adjustment plate having a center pivot hole coupled to said pivot rod of said first spray pattern plate, a plurality of water jet holes alternatively set into communication between the water jet holes of said first spray pattern plate and the water jet holes of said second spray pattern plate, and a finger rod extending from the periphery thereof to the outside of said nozzle head through said sliding slot of said nozzle head for operation; and
a spray cap covered on said nozzle head over said spray pattern dial, said spray cap having a plurality of water jet holes respectively disposed in communication with the water jet holes of said second spray pattern plate.

2. The water spray gun as claimed in claim 1, wherein said water chamber of said body has a pivot hole and a bearing hole at two opposite sides, said bearing hole having mounted therein a socket and a stopper cap, said socket having an arched guide face fitting over the periphery of said spherical valve block, a water outlet opening cut from a part of said arched guide face for communication with the peripheral notch of said spherical valve block, said stopper cap having a through hole; said water control valve having a stem extending out of two opposite sides of said valve block and respectively pivotally connected to the pivot hole of said water chamber and the through hole of said stopper cap; said control lever having two opposite ends respectively affixed to said stem outside said body.

3. The water spray gun as claimed in claim 1, further comprising a water outlet fitting fixedly mounted inside said water outlet passage of said body, said water outlet fitting having a water guide hole curved inwards at one end thereof and attached to the periphery of said valve block of said water control valve for communication with the peripheral notch of said valve block to guide in water and a stepped water hole at an opposite end thereof for output of water.

4. The water spray gun as claimed in claim 1, wherein said nozzle head has a water hole in a rear mounting portion thereof in communication with said water outlet passage of said body, a front coupling portion, a step in said front coupling portion, a tapered guide portion connected between the rear mounting portion and front coupling portion of said nozzle head, and a plurality of teeth spaced around an inside wall of said tapered guide portion; said nozzle head has mounted therein a buffer member for buffering the pressure of water passing therethrough, said buffer member having a rear mounting portion fixedly fastened to an inside wall of the rear mounting portion of said nozzle head and a sliding groove connected to said sliding slot of said nozzle head.

5. The water spray gun as claimed in claim 4, wherein said buffer member has a stop wall supported on the step and teeth of said nozzle head, and a water hole cut through said stop wall.

6. The water spray gun as claimed in claim 4, wherein said buffer member has a front accommodation portion, which accommodates said spray pattern dial.

7. The water spray gun as claimed in claim 1, wherein the water jet holes of said first spray pattern plate include an upper water jet hole and a lower jet hole respectively disposed at an upper side and a lower side relative to the pivot rod of said first spray pattern plate; the water jet holes of said second spray pattern plate include an upper water jet hole and a lower jet hole respectively disposed at an upper side and a lower side relative to the center mounting hole of said first spray pattern plate.

8. The water spray gun as claimed in claim 7, wherein said second spray pattern plate has a smoothly arched water accumulation groove disposed in communication with the upper water jet hole of said second spray pattern plate.

9. The water spray gun as claimed in claim 1, wherein the water jet holes of said adjustment plate include an upper water jet hole and a lower jet hole respectively disposed at an upper side and a lower side relative to the center pivot hole of said adjustment plate.

10. The water spray gun as claimed in claim 1, wherein the water jet holes of said spray cap include upper water jet holes cut arranged along a smoothly arched line and respectively separated from one another vertical ribs at a front side of said spray cap.

11. The water spray gun as claimed in claim 1, wherein the water jet holes of said spray cap includes a lower water jet hole in communication with one lower water jet hole of the water jet holes of said second spray pattern plate.

12. The water spray gun as claimed in claim 1, wherein said notch of said spherical valve block is crescent shaped.
